(19) United States
(12) Patent Application Publication
(10) Pub. No.: US 2012/0312672 A1
(43) Pub. Date: Dec. 13, 2012

(54) PUSH BUTTON ASSEMBLY AND ELECTRONIC DEVICE HAVING THE SAME

(75) Inventors: KUN-CHIH HSIEH, Tu-Cheng (TW); HONG-GUO ZHOU, Shenzhen City (CN); JIAN-QIANG ZHAO, Shenzhen City (CN); CHAO-CHAO FENG, Shenzhen City (CN); XIAO-BO LOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/279,318

(22) Filed: Oct. 23, 2011

(30) Foreign Application Priority Data
Jun. 10, 2011 (CN) 201110155145.5

(51) Int. Cl. H01H 1/06

(52) U.S. Cl. 200/517

(57) ABSTRACT

A push button assembly for use in an electronic device includes a plate, a circuit board, an elongated button and an elastic element. The plate is arranged within the electronic device. The circuit board is fixed to the plate. The circuit board includes a switch. The elastic element is fixed to the plate. The elastic element includes an elongated depressible portion arranged between the circuit board and the button. The depressible portion extends along a lengthwise direction of the button and is deformable by depression of elongated button. The disclosure also provides an electronic device having the push button assembly.

### BACKGROUND

1. Technical Field

The present disclosure relates to a button assembly, especially to a push button assembly and an electronic device having such push button assembly.

2. Description of Related Art

Many push button assemblies include a switch and a button that, when pressed, actuates the switch. For an elongated button, if a user does not push the button very straight, there will be greater resistance to the pushing from the button being canted in its slot, which can be uncomfortable to a user and even cause injury.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partial, isometric view of an electronic device according to an exemplary embodiment.

FIG. 2 is an exploded view of the electronic device in FIG. 1.

FIG. 3 is a partial, cross-sectional view taken along the line III-III of FIG. 1.

### DETAILED DESCRIPTION

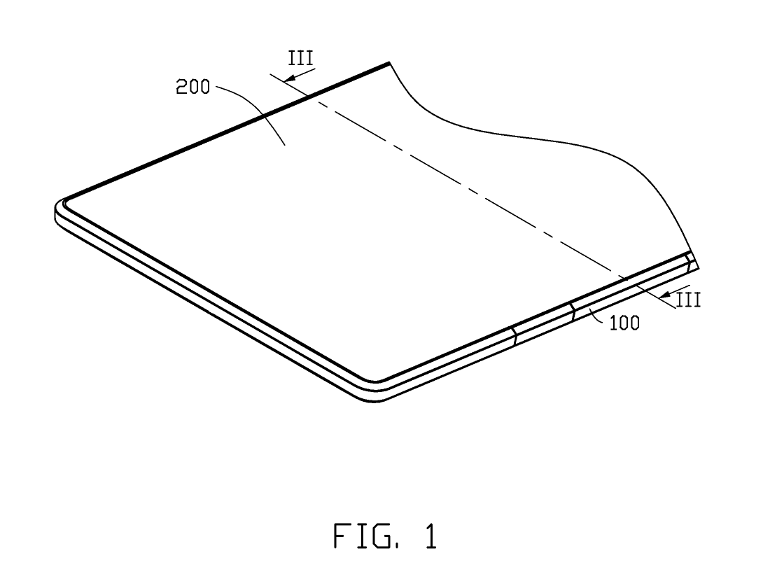

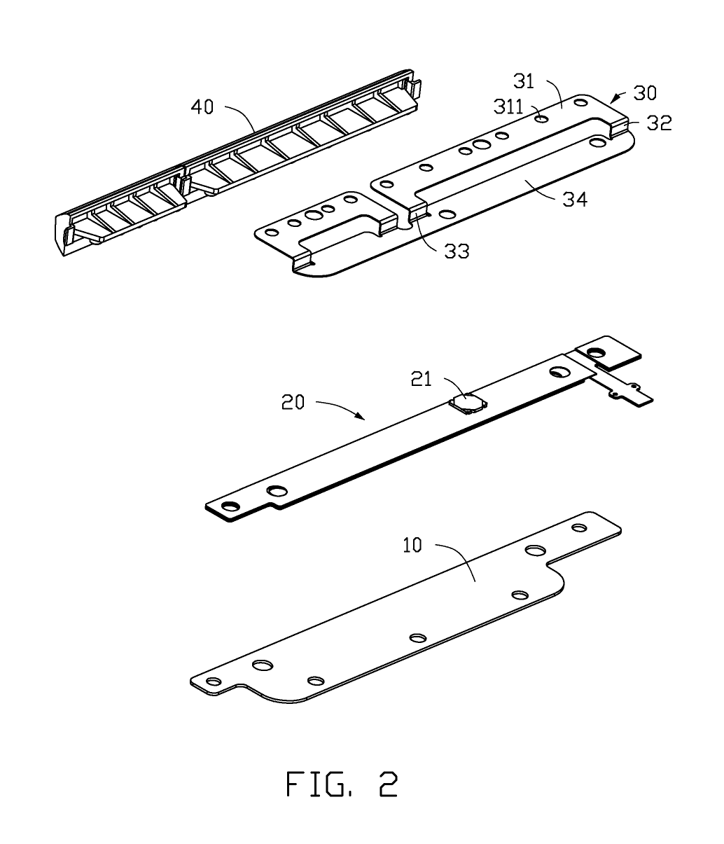

Referring to FIGS. 1 and 2, according to an exemplary embodiment, a push button assembly 100 for use in an electronic device 200 includes a rigid plate 10, a circuit board 20, an elastic element 30, and a button 40.

The rigid plate 10 has an elongated planar structure. The rigid plate 10 is arranged in a housing of the electronic device 200. In the exemplary embodiment, the rigid plate 10 is made of metal.

The circuit board 20 has a substantially elongated shape and is stacked on the rigid plate 10. The circuit board 20 includes a switch 21.

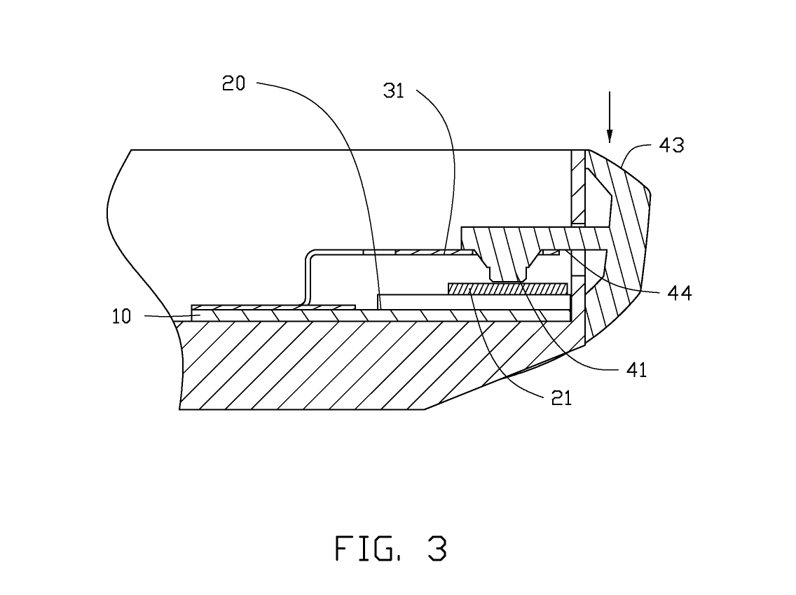

Referring to FIG. 3, the button 40 includes a pressing portion 43 and a lever 44. The pressing portion 43 has an elongated shape. The lever 44 protrudes from the inner surface of the pressing portion 43 along and throughout the length of the pressing portion 43. The lever 44 includes a protrusion 41. The protrusion 41 is located above the elastic element 30.

The elastic element 30 includes a depressible portion 31 a fixing portion 34 fixed to the rigid plate 10. The depressible portion 31 is substantially an elongated plate and extends along the lengthwise direction of the button 40. The depressible portion 31 is substantially as long as the button 40. The depressible portion 31 is disposed between the circuit board 20 and the button 40. The depressible portion 31 defines a through hole 311 aligned with the switch 21. The protrusion 41 extends through the through hole 311 toward the switch 21. The button 40 can be fixed to the elastic element 30 by conventional connection techniques, such as screws. The elastic element 30 further includes a first elastic arm 32 and a second elastic arm 33 bending from opposite ends of the depressible portion 31 at a same side thereof. The ends of first elastic arm 32 and the second elastic arm 33 are both connected to the fixing portion 34.

When pressed, the button 40 moves and moves the elastic member 30. The protrusion 41 then actuates the switch 21. The first elastic arm 32 and the second elastic arm 33 are thus deformed when the button 40 moves the elastic member 30. Because the depressible portion 31 has the substantially length equal to that of the button 40, the button 40 can be pushed from different angles and will still easily cause the elastic element 30 to be deformed, thus the button 40 need not be operated so precisely and pushing it with standard force will not result in discomfort or injury to the user.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A push button assembly for use in an electronic device, comprising:
a plate for being arranged within the electronic device;
a circuit board fixed to the plate, the circuit board comprising a switch;
an elongated button; and
an elastic element fixed to the plate, the elastic element comprising an elongated depressible portion arranged between the circuit board and the button, the depressible portion extending along a lengthwise direction of the button and being deformable by depression of the elongated button.

2. The push button assembly of claim 1, wherein the length of the depressing portion is substantially equal to that of the button.

3. The push button assembly of claim 1, wherein the elastic element further comprises a fixing portion fixed to the plate, a first elastic arm and a second elastic arm, the first and second elastic arms depending from opposite ends of the depressible portion at a same side thereof, and the first elastic arm and the second elastic arm are both connected to the fixing portion.

4. The push button assembly of claim 1, wherein the depressible portion defines a through hole aligned with the switch, the button comprises an elongated pressing portion and a lever formed on the pressing portion, the lever extending along and throughout the length of the pressing portion, a protrusion extending from the lever through the through hole toward the switch.

5. An electronic device comprising:
a housing;
a push button assembly comprising:
a plate arranged within the housing;
a circuit board fixed to the plate, the circuit board comprising a switch;
an elongated button; and
an elastic element fixed to the plate, the elastic element comprising an elongated depressible portion arranged between the circuit board and the button, the depressible portion extending along a lengthwise direction of the button and being deformable by depression of the elongated button.

6. The electronic device of claim 5, wherein the length of the depressing portion is substantially equal to that of the button.

7. The electronic device of claim 5, wherein the elastic element further comprises a fixing portion fixed to the plate, a first elastic arm and a second elastic arm, the first and second elastic arms depending from opposite ends of the depressible portion at a same side thereof, and the first elastic arm and the second elastic arm are both connected to the fixing portion.

8. The electronic device of claim 5, wherein the depressible portion defines a through hole aligned with the switch, the button comprises an elongated pressing portion and a lever formed on the pressing portion, the lever extending and throughout the length of the pressing portion, a protrusion extending from the lever through the through hole toward the switch.
